(19) United States
(12) Patent Application Publication
(10) Pub. No.: US 2010/0293105 A1
(43) Pub. Date: Nov. 18, 2010

(54) SOCIAL NETWORKING UPDATES FOR IMAGE DISPLAY DEVICES

(75) Inventors: Arnold Blinn, Bellevue, WA (US); Cynthia Hagan, Seattle, WA (US); Timothy Herby, San Mateo, CA (US); Carl Hirschman, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/467,247

(22) Filed: May 15, 2009

(51) Int. Cl. G06Q 99/00; G06F 3/048; G06F 15/16

(52) U.S. Cl. 705/319; 715/733; 709/203

(57) ABSTRACT

A web-based update service is arranged to collect data from online social networking services (and other applications and services) to keep users informed and up to date with the activities of their social networking contacts (and up to date on data from other services) by processing the collected data into an update for display in a format that is consumable by non-interactive and low-interactive display devices that have relatively limited rendering capabilities. The data collected from the applications may be stored, parsed, and categorized so that it can be bundled into an update that is responsive to the user's input and preferences. The service transcodes the content in the update into the proper format required for display on the device. The update can be directly delivered to the display device over a network connection if the device is equipped with a network interface, or via an intermediary device like a networked personal computer.

### BACKGROUND

Online social networking applications are gaining widespread popularity as consumers increasingly look to the Internet as a way to share ideas, feedback, and files, or to simply keep in touch with their contacts such as colleagues, acquaintances, friends, and family. Social networks users can also bond over shared interests and opinions. Social networking has proven to be broadly appealing and attracts a diverse group of users who can use personal computers (“PCs”) and portable devices like mobile phones to retrieve updates from their social networks.

Social networking utilizes the concept of personal spaces where users can build a web page to create an online presence. Sites such as Facebook®, MySpace™, Twitter™, Microsoft Corporation's Windows Live™ Spaces and many others with global or local reach encourage and enable users to exchange information about themselves with the world-at-large. Users can connect with their contacts to share thoughts and experiences using, for example, blogs, comments, email, instant messaging, photographs, and video, as well as meet new people or generally interact with other people's online personalities. Social networking can thus provide an outlet for creativity, giving users a way to express their individuality while satisfying their need to be part of a community.

### SUMMARY

A web-based update service is arranged to collect data from online social networking (and other applications and services) to keep users informed and up to date with the activities of their social networking contacts (and up to date on data from other services) by processing the collected data into an update for display in a format that is consumable by non-interactive and low-interactive display devices that have relatively limited rendering capabilities. The update service may be configured to expose an interface to the user for setting preferences and making choices such as the sources for the data, which contacts are included, the content types, and the frequency and content of the updates.

The update service can store, parse, and categorize the data collected from the applications so that content can be bundled into an update that is responsive to the user's choices and preferences. The update service may transcode the content in the update into the proper format as needed for display on the device. The update can be directly delivered to the display device over a network connection if the device is equipped with a network interface, or via an intermediary device like a networked PC.

In various illustrative examples, the update service is configured to interoperate with digital picture frames. These are display devices that support only limited user interactivity (compared with other devices which can also render and interact with content like PCs or mobile phones) and which can typically only display content in image formats such as JPEG (Joint Photographic Experts Group) and the like. As such, content from the activities on the social networking sites would be transcoded into the specific format required for rendering on a specific type of display device. Some digital picture frames can display images from local storage or images which are received from a host PC. Network interfaces, such as Wi-Fi wireless interfaces, are also incorporated into some digital picture frames to provide additional network paths over which images may be received for display. In this case, the update service can deliver a social networking update to a digital picture frame as an image, or series of images using an RSS (Really Simple Syndication) feed over the Internet.

By parsing and categorizing the collected data, the update service may establish and track contextual relationships among the data so that various combinations of content can be rendered into images for display on the digital picture frame. This enables contextually-related content to be bundled together into an update that is relevant and of interest to the user. For example, contextually-related social networking content can be retrieved and bundled together or mixed with non-social networking content to create interesting and compelling combinations.

The user interface is arranged to allow users to explicitly set preferences and select criteria that the update service employs when collecting and processing the data. The update service can apply weighting to the data to tailor the update to the user responsively to the preferences. In some implementations, the update service can also be configured to apply business logic to make inferences about what a user would like to receive when the service generates an update.

Advantageously, the update service expands the ability of users to stay current with developments in their social networks. By enabling social networking updates to be rendered on display devices like digital picture frames, users can keep up to date without having to be online at their computer. The update service also facilitates a rich user experience by giving control to the user over how updates are created and by providing the social networking and other content that is included in the updates in context.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative on-line environment that supports various applications, home networks, and an update service;

FIG. 2 shows details of a typical home network that supports a variety of client devices including computing devices with relatively full processing capabilities and devices having relatively limited processing capabilities;

FIG. 3 shows a set of illustrative components that may run on a client computing device such as a PC;

FIG. 4 shows a typical usage scenario in which a digital picture frame is configured to retrieve images from a PC, from local storage, or via a connection to the Internet;

FIG. 5 shows a set of illustrative components that may run on a digital picture frame;

FIG. 6 shows an illustrative arrangement for processing social networking and other data to generate updates that may be displayed as images on a digital picture frame;

FIG. 7 shows illustrative functionality that may be exposed by a user interface that is supported by the update service;

FIG. 8 shows an illustrative image of a social networking update that a digital picture frame can render; and

FIG. 9 shows an illustrative sequence of images having social networking and related content that the digital picture frame can render.

Like reference numerals indicate like elements in the drawings. Elements are not drawn to scale unless otherwise indicated.

### DETAILED DESCRIPTION

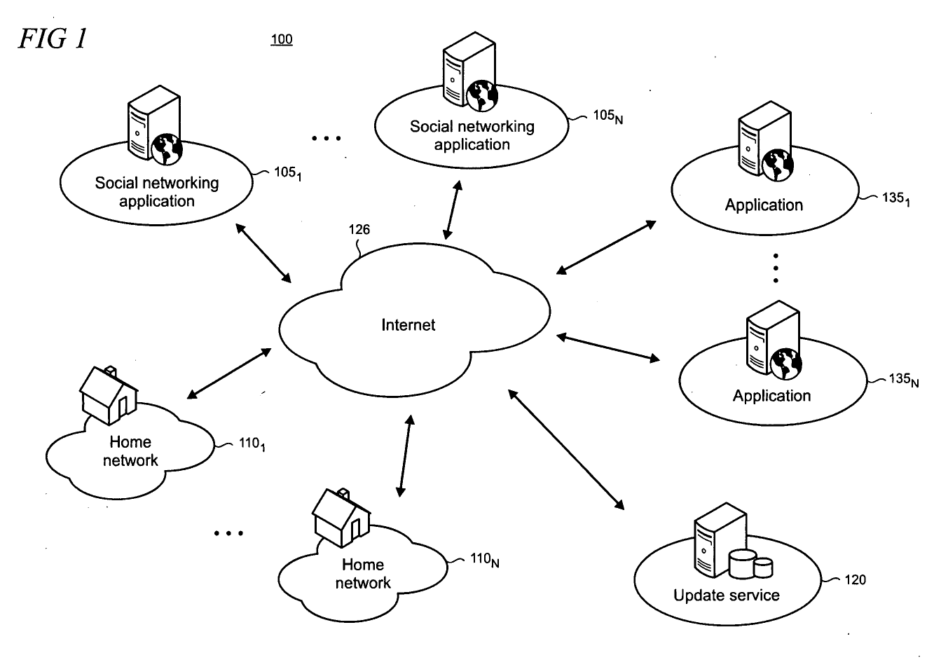

FIG. 1 shows an illustrative online environment 100 that supports various applications, home networks 110_{1 . . . N}, and an update service 120 that are coupled over a wide area network such as the Internet 126. In this example, social networking applications 105_{1 . . . N} each support social networking experiences for users and are typically web-based. Social networking application users can engage in a variety of activities including representing themselves online, communicating and socializing with contacts, authoring and sharing content, posting comments and blogs, uploading content such as music, video, photographs, and multimedia, collaborating and sharing thoughts and ideas, and the like. Different providers can support the social networking applications. For example, one application can be Facebook while another can be Microsoft Live Spaces, etc.

Users can also typically interact with the social networking applications 105 to create and update user profiles which are utilized as the online representation of the user's real world personality. User profiles can include various types of data—such as demographic information, interests, hobbies, likes/dislikes, education, job/profession, and other expressions of taste, beliefs, personality, or identity, etc.—to enable users to share information about themselves.

Other applications 135_{1 . . . N} are also present in the environment 100 which may provide other content to users in the environment 100 and/or support other applications such as media sharing (like video, audio, or photo sharing), topical forums, games/entertainment, news and information, traffic, weather, other web-based experiences, and the like. Other sources of content (not shown) that may be included in social networking updates may also be supported in the environment 100. The applications 135 and content sources may be configured in some cases to supply RSS feeds.

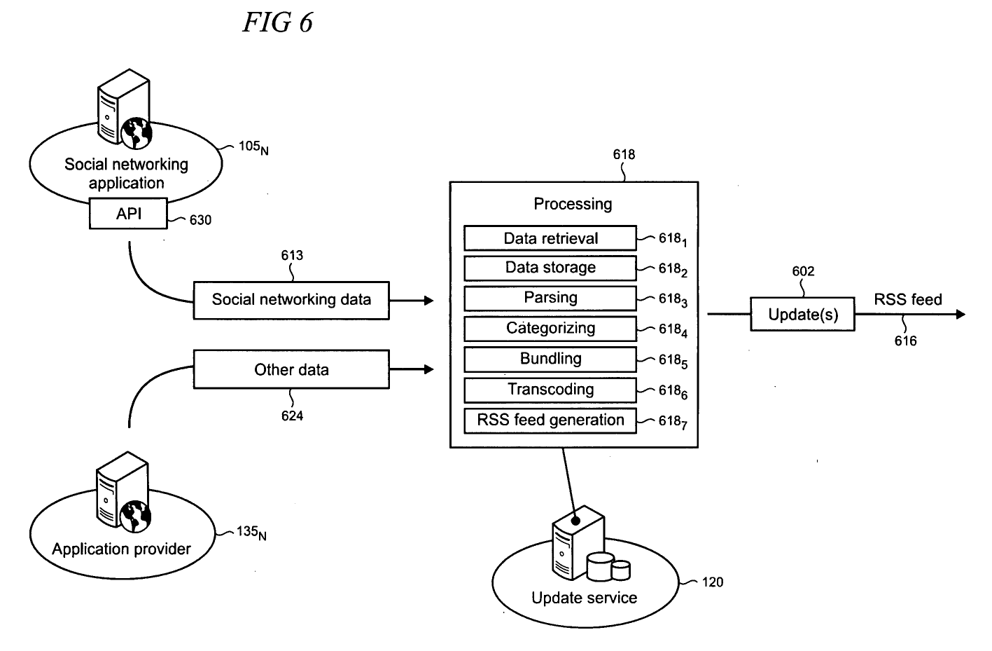

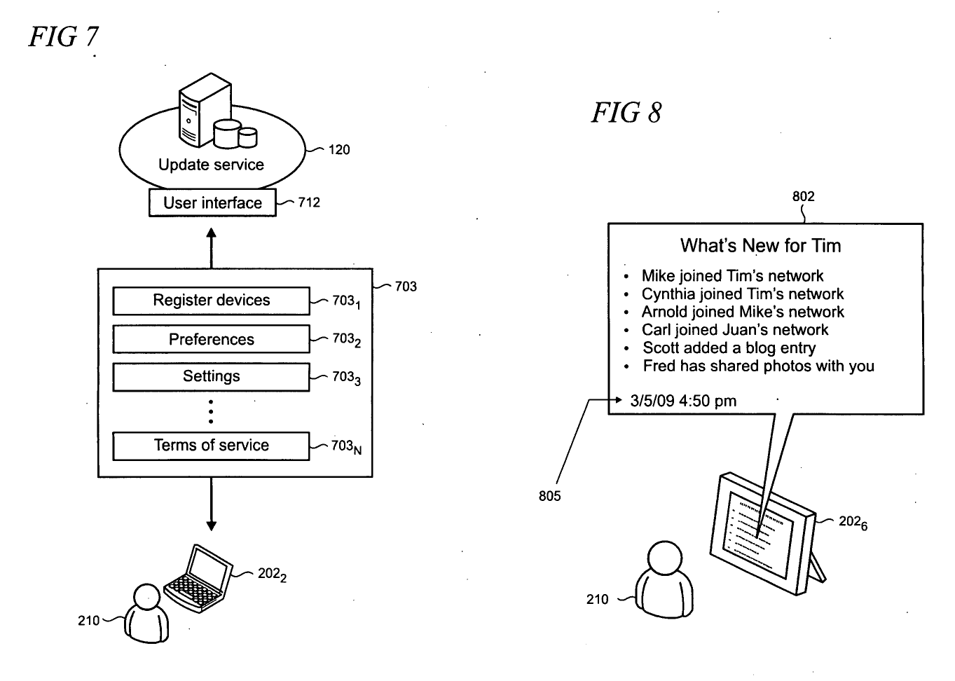

The update service 120 is arranged, in this illustrative example, as a standalone web-based service that collects and processes data from the applications 105 and 135 in the environment 100 in order to generate social networking updates that can be rendered by display devices having limited capabilities like digital picture frames. Alternatively, the update service 120 may be integrated as part of an offering or service supported by one of the application providers in the environment 100. The update service 120 can also expose an interface to enable users of the service to set up devices, set preferences, and exercise some control over how the updates are generated. Each of these features (i.e., collecting/processing and exposing the user interface) is respectively described in more detail below in the text accompanying FIGS. 6 and 7.

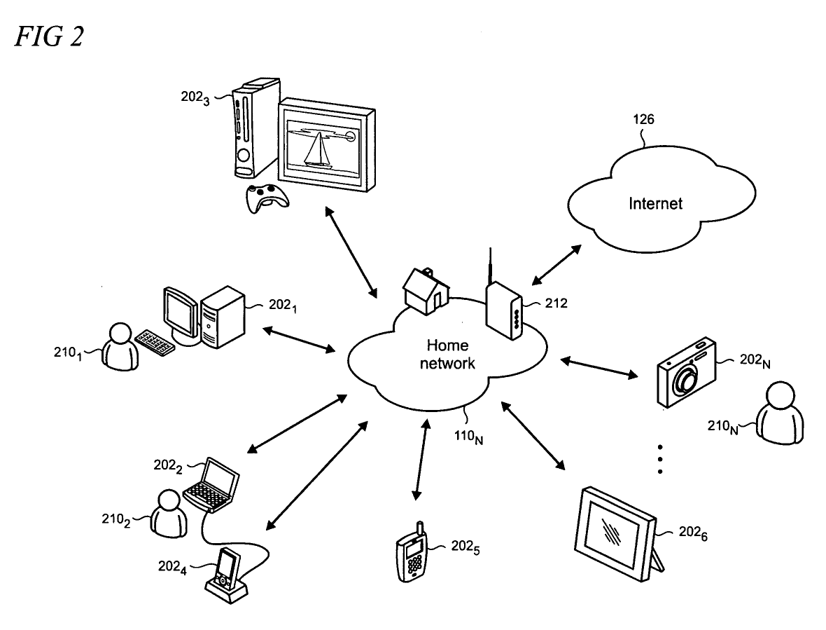

FIG. 2 shows details of a typical local area or home network 110 that supports a variety of client devices 202 including computing devices with relatively full processing capabilities as well as devices having relatively limited processing capabilities. The client devices with relatively full processing capabilities may comprise, for example, a desktop PC 202₁, laptop PC 202₂, and game console 202₃, while the more limited devices include a media player 202₄ such as an MP3 player (Moving Pictures Expert Group, MPEG-1, audio layer 3), smartphone or mobile phone 202₅, digital picture frame 202₆, and digital camera 202_{N}. The home network 110 can typically support a variety of users 210.

It is emphasized that the client devices 202 shown are intended to be illustrative and that other devices with varying capabilities may be utilized in a given home network to meet the needs of a particular implementation. For example, devices like network-attached storage and home network servers can be deployed in some home networks.

The client devices 202 in this example include network interfaces that may comply with one or more of a variety of conventional interfaces such as Ethernet under IEEE (Institute of Electrical and Electronics Engineers) 802.3 and wireless WiFi under IEEE 802.11. The network interfaces enable the client devices 202 to be connected to the home network 110 in order, for example, to share files and content and access peripherals such as printers in some cases. A router and network gateway combination device 212 is utilized that allows the client devices 202 on the home network 110 to share a connection to the Internet 126. In this example, the router/gateway 212 can support both wired and wireless interfaces and typically functions as a DHCP (Dynamic Host Configuration Protocol) server that can automatically assign IP (Internet Protocol) addresses to the client devices 202.

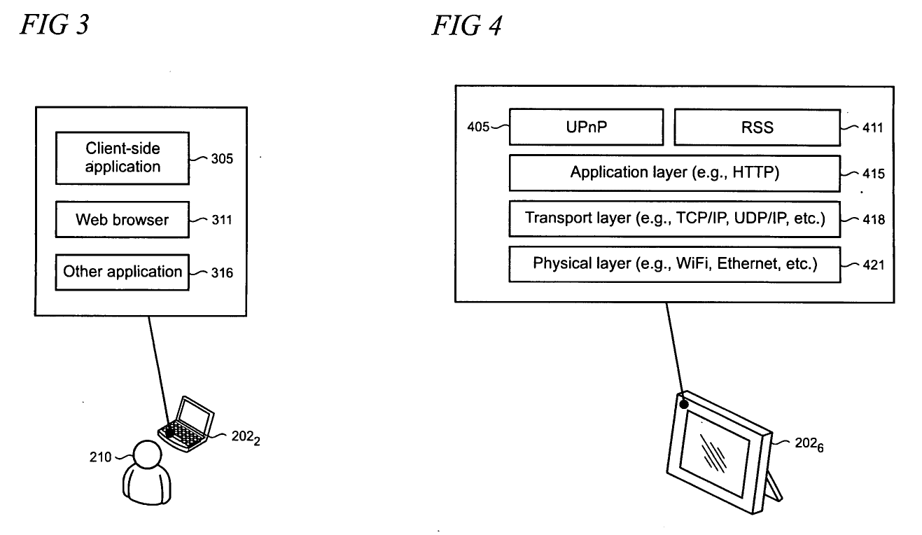

As shown in FIG. 3, the PCs in the home network 110 (represented by laptop PC 202₂) will typically host one or more software components such as a client-side application 305, web browser 311, or other application 316. In a given usage scenario, one or more of such components could be employed to enable the user 210 to use various online applications 105 and 135 (FIG. 1). However, web browsers are commonly employed as a general purpose client that can interact with multiple different online applications or services.

The digital picture frame 202₆, in this illustrative example, is representative of a class of non-interactive display devices that are available in the market. These are devices that are capable of rendering some media content formats while supporting a streamlined user interface. In this example, the digital picture frame 202₆ employs a screen, typically an LCD (liquid crystal display, to display content that is typically restricted to image formats such as JPEG, GIF (Graphics Interchange Format), BMP (bitmap), TIFF (Tagged Image File Format), PNG (Portable Network Graphics), etc., although some frames can also render multimedia content such as video and audio. Digital picture frames are also referred to as digital media frames.

Digital picture frames and other non-interactive display devices generally support a streamlined user interface using input devices like buttons (not shown). While the user interface allows content to be rendered on the frame with minimal user intervention, it will also typically impose some limits on the scope of interactivity. For example, the frame's user interface may support simple playback controls like play, stop, and pause, but not a complete set of functionalities that would usually be needed to browse and select available content.

The limitations on content formats and user interface means that the digital picture frame 202₆ will have fewer capabilities when compared, for example, to the PCs and game consoles in the home network 110 (FIGS. 1 and 2). However, such limitations are implemented by design and digital picture frames have proven to be very popular with consumers particularly as frame availability has become more widespread and increased competition has made pricing attractive. Digital picture frames are available in the marketplace having varying aspect ratios and screen resolutions.

Other devices that are configured or operate as “low-interactive” devices can be alternatively utilized in some implementations. Such devices will generally include features and capabilities that are more comprehensive than that supported by a non-interactive device. While not supporting a full set of interactive controls as in a high-interactive device like a PC or game console, a digital picture frame (or other device) when configured as a low-interactive device may include user controls (such as buttons, switches, and the like) and associated logic to enable the user to express approval (or disapproval) of content in an update. In some implementations, the built-in buttons/controls can be supplemented by external control devices like keyboards and other user interfaces which can be coupled to the device using a hardwired connection or via wireless interfaces such as Bluetooth.

For example, when the update plays as a slideshow, the buttons could be configured to invoke preset functionality such as “show me more like this” and/or “show me less like this,” and the like. Activation of the respective buttons indicates to the update service that the user would like to see more or less content that is similar to a given piece of content being rendered in the slideshow. Similarly, the controls can enable the user to forward content or provide comments and feedback using presets like “send this to my social network”, “send this to my friends”, “cool picture”, or “I like this”, etc. Thus, a low-interactive device can enable the user to exercise some degree of control over which content is rendered, how it is rendered and/or support the use of comments and feedback in some cases.

It is emphasized that the present update service is not limited to interoperating strictly with non-interactive and low-interactive devices. In some scenarios a user may wish to use a high-interactive device to render the update. Such devices typically support a fully interactive user experience with the use of comprehensive user interfaces. However, a high-interactive device can generally be configured and used in a way that mimics the user experience provided by less capable devices, even if that means that some available features and capabilities are not utilized.

It is noted that many devices served by the update service may be generally characterized as “passive consumption” devices when supporting the user experiences described herein. In such cases the user experience will typically involve watching portions or all of the update and, when the device is configured to support such features, exercising some control over the rendering of the content at the device and/or providing comments, feedback, etc. Passive consumption can often occur in the context of other activities. Thus, for example, the present service can provide social networking updates that play during a party or other social event on a digital picture frame, or on a PC or game console that is utilized to render the update.

FIG. 4 shows a set of illustrative components that may run on the digital picture frame 202₆ and which are typically implemented using software, hardware, firmware, or a combination thereof. The components include a UPnP (Universal Plug and Play) component 405 and an RSS component 411 that expose functionality to retrieve images from respective UPnP and RSS sources. These components are configured to interoperate with conventional communication protocols implemented in this example using an application layer 415 such as HTTP (Hypertext Transfer Protocol), a transport layer 418 which may comprise TCP/IP (Transport Control Protocol/Internet Protocol), and a physical layer 421 such as WiFi or Ethernet.

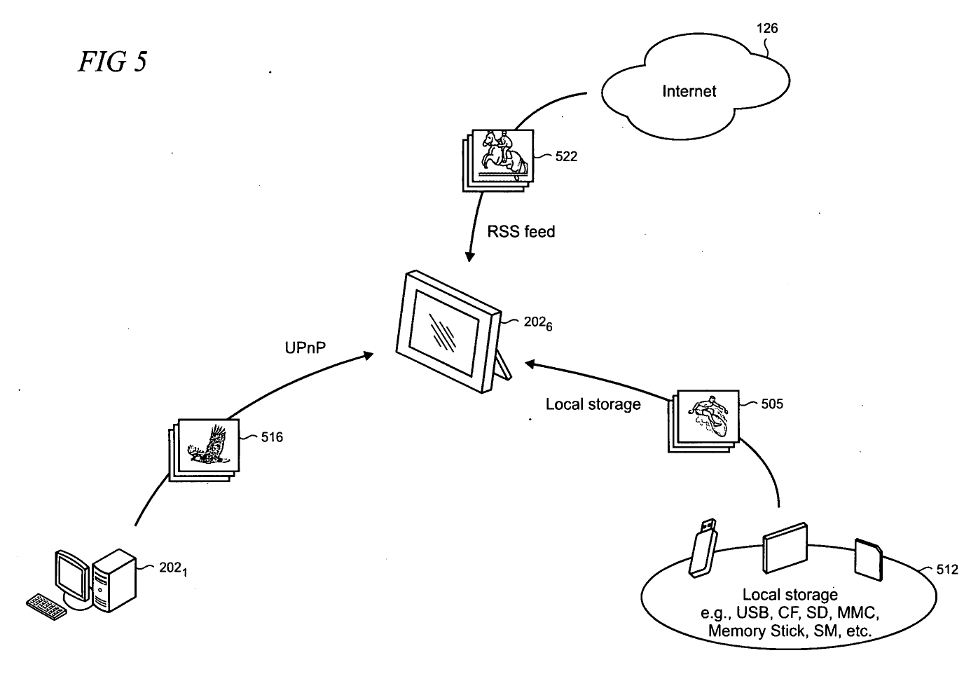

As shown in FIG. 5, users frequently set up their digital picture frames to receive images 505 from local storage 512. The local storage 512 can comprise various conventional portable storage media such as USB (Universal Serial Bus) drives and cards such as CF (CompactFlash), SD (Secure Digital), MMC (Multi-Media Card), SM (SmartMedia), Memory Sticks, and other forms of portable memory or mass storage such as USB hard drives. The user 210 (FIG. 2) can also capture images using the camera 202_{N} on a storage medium like a CF card (or copy images to the media from the camera's internal storage) and then physically transfer the media to the digital picture frame 202₆. Some digital picture frames include interfaces to support multiple storage media types.

The digital picture frame 202₆ will generally show the images from the local storage 512 in a slideshow. Options like display order (e.g., random, sequentially by date, etc.), speed, transitions and effects, etc., can typically be set through the frame's user interface.

As users often store their collections of photographs on their PCs, the digital picture frame 202₆ is also configured to retrieve images 516 from one of the PCs 202₁ in the home network 110. While users can copy images stored on their PCs to a portable storage medium, in this example the digital picture frame 202₆ is equipped with a wireless network interface that allows images 516 to be retrieved from the PC 202₁ over the home network 110 using the UPnP protocol as described by the Digital Living Network Alliance (“DLNA”™) standards. In alternative embodiments, the digital picture frame 202₆ can be tethered to the PC 202₁ to facilitate the exchange of images using a cable interface such as USB or the frame can be coupled to the network router/gateway 212 using another physical interface such as a wired Ethernet.

The network interface supported by the digital picture frame 202₆ further enables images 522 to be retrieved, for example, from RSS sources as well as the update service 120 (FIG. 1) over the Internet 126. In this example as shown in FIG. 6, the update service 120 provides images as social networking updates 602 to the digital picture frame. The update service 120 is arranged to collect social networking data 613 from one or more of the social networking applications 105 and perform processing 618 to generate the update 602 that can be rendered by the digital picture frame using an RSS feed 616 that is transmitted to the frame over HTTP. RSS feeds are typically implemented using an XML-based (eXtensible Markup Language) data file that contains a list of items, and in particular items that contain a URL (Uniform Resource Locator) for an image on the Internet. Accordingly, the update service 120 will generate the RSS feed 616 as well as some or all of the images contained therein.

In alternative implementations, an update 602 may be transmitted to the digital picture frame 202₆ via an intermediary device in the home network such as a PC. In this usage case, a client application on the PC is arranged to receive the RSS feed 616 which can then be relayed to the digital picture frame 202₆ using a connection such as UPnP, USB, or using portable storage media as described above.

In some implementations, the social networking data 613 can be supplemented with other data 624 that is collected from another application provider 135 or content source. For example, an application 135 can provide a source of data that may be contextually related in some way to data in a social networking update. Examples might include profile photos or related updates from other services. Alternatively, the update service 120 can collect data from an application 135 that might not be related to social networking but may still be of interest to a user of the update service. Examples might include news, weather, sports, stock quotes, etc.

The social networking application 105 in this example is configured to expose an API (application programming interface) 630 to facilitate the collection of the social networking data 613 by the update service 120. If data is desired but a provider does not provide an API (as is the case with the application provider 135_{N} in this example), data can be scraped, extracted, or mined using any of a variety of conventional techniques.

The processing performed by the update service 120 will typically be performed in an automated manner through the execution of code on one or more servers (i.e., specialized computing platforms that are configured to implement various portions of the update service and interface with the client devices 202 in a home network 110). Such computing platforms will typically comprise a variety of components including a processor, a read only memory (“ROM”), memory, input devices (e.g., keyboards and pointing devices such as mice), output devices (e.g., display monitors), storage devices, and communications interfaces (e.g., including a transceiver for communicating via one or more networks) that are typically operatively coupled by a bus. The memory may be random access memory (“RAM”) or another type of dynamic storage device that stores information and instructions for execution by processor. The memory may also store temporary variables or other intermediate information used during execution of instructions by the processor. The ROM may include a conventional ROM device or another type of static storage device that stores static information and instructions for the processor. The storage device may include compact disc (“CD”), digital versatile disc (“DVD”), a magnetic medium, or other type of storage device for storing data and/or instructions for the processor.

The processing in this example includes data retrieval (as indicated by reference numeral 618₁ in FIG. 6) from the applications 105 and 135 through interaction with the API 630 or data scraping, etc. The update service 120 will typically store the retrieved data (618₂) in appropriate data stores or databases.

As social networking data can include many items of one (e.g., many comments made by users regarding a single object), or include combinations of multiple types of data, the collected data is parsed (618₃) into its constituent pieces of information. For example, the update service 120 will identify and parse text comments from a blog entry and parse photographs that have been shared with the user, etc. Non-social networking data can also be similarly parsed in some implementations.

Once parsed, the update service 120 will categorize the data (618₄) so that data pertaining to a particular contact, or data of similar types, can be handled by category. For example, categorization enables data items to be grouped by user or by type, and the update service can give some categories more weight when an update is generated. In addition, by parsing and categorizing the various types of content in the data, the update service 120 can put social networking and other content into context. Such context enables the update service 120 to bundle related pieces of content from various categories into updates (618₅) that are appealing and interesting and responsive to the user's preferences.

Preferences can be explicitly expressed by the user through the interface that is exposed by the update service 120 (as described below in the text accompanying FIG. 7) or the service may apply business logic to derive or make predictions about likely user preferences using, for example, collaborative filtering and other conventional techniques. In some cases, preferences that the user has set in his or her social network profile can be retrieved and utilized by the update service 120.

The update service 120 transcodes the update (618₆) from the content's native format (i.e., text, HTML (HyperText Markup Language), XML, metadata (i.e., data describing how, when, and where the content was created and by whom), and/or other non-image-based content) into an appropriate format for rendering by the digital picture frame 202₆. In this example, an image format such as JPEG is used, however the format and other criteria such as size, aspect ratio, color depth, etc. can vary depending on the requirements of a given implementation and the particular capabilities of the digital picture frame.

In alternative implementations, other image formats such as TIFF, GIF, PNG, etc. can be utilized, as well as video formats when video is supported by a given display device. Common video formats include, for example, WMV (Windows Media Video), RealVideo, QuickTime, those covered by MPEG (Moving Picture Experts Group), and the like, which are processed for rendering using an appropriate video codec that is installed on the display device, A given update can utilize a single or multiple images which the update service 120 will provide to the digital picture frame 202₆ by generating an RSS feed (618₇) in this example, where the appropriate number of images are included as items in the feed.

FIG. 7 shows illustrative functionality 703 that may be exposed to the user 210 by a user interface 712 that is supported by the update service 120. The user interface 712 can be implemented on a client device 202 using, for example, a web browser or other application in the case of a PC (such as the laptop 202₂ as shown in FIG. 7) or using a mobile browser in the case of a portable device such as a mobile phone. The service's collection of data and how particular categories of data are utilized and bundled will generally be dependent on the options that are surfaced to the user. In this example, the user interface 712 exposes functionality to the user 210 which includes registering devices such as a digital picture frame (as indicated by reference numeral 703₁), setting preferences as to how the update service operates (703₂), establishing settings (703₃), and receiving and agreeing to terms of service under which the update service is provided (703_{N}). In this illustrative example, perhaps most important are the settings for what content to actually aggregate from the external services (e.g. what services from the applications 105 and 135 in FIG. 1 should be used) and for which members of their social network the updates should be included.

It is emphasized that these particular functions are intended to be illustrative and that others may be utilized in any given implementation of the present update service as may be required. For example, other functionality may be provided in some instances to give users more comprehensive programmatic control over how updates are created and which criteria are utilized.

The user 210 can employ the device registration functionality 703₁ exposed by the user interface 712 to obtain the web address (i.e., URL) of the RSS feed for the user's update. The web address can be displayed to the user 210. The user can then manually enter the address into the digital picture frame 202₆ using the frame's user interface, or in some cases use a coupled PC as a controller to configure the frame with the RSS address. The digital picture frame 202₆ will go to the web address and pull down the update from the service 120. The frame will thereafter periodically poll the address and pull down additional updates when, for example, the update service 120 has retrieved new data from an application and added content to an update. The polling frequency can vary by implementation but generally will be set to be performed at short enough intervals to keep the social networking updates fresh and timely. This parameter can also be exposed to be user-settable in some cases, or it can be computed by the update service 120 and returned in the feed (as an RSS TTL (Time-to-Live) value).

In alternative implementations, the update service 120 can be configured to pair the digital picture frame 202₆ to a web service identity such as a Microsoft Windows Live ID (i.e., the credential used to authenticate to Windows Live services). In this case, the digital picture frame 202₆ will query a web service supported by the update service 120 for a listing of the user's RSS feeds (where each update can be a unique RSS feed). A similar web service is utilized by Windows Live FrameIt to expose collections (rather than the social networking updates here) to paired devices and is described at http://frameit.live.com/service/devicesvc asmx?WSDL and http://frameit.live.com/service/devicesvc.asmx.

The user 210 may set preferences using the preferences functionality 703₂ to specify criteria that the update service 120 can utilize when collecting and processing the application data to create an update. The particular options exposed to the user can vary by implementation but may comprise setting preferences and/or exercising control over some or all of the following:
1. Social networking applications. The user 210 can specify to the update service 120 which social networking or other applications are to be utilized as sources of collected data (e.g., data 613 and 624 in FIG. 6 or applications 105 and 135 in FIG. 1) for the updates. For example, one user might want updates limited to developments and activities that pertain to a particular social networking application (e.g., Facebook but not Windows Live Spaces) while another user may wish the update service 120 to collect data from multiple different applications. Similarly, a user might want updates from non-social network sites;
2. Social networking contacts. The user can set the particular social networking contacts from whom data is collected for inclusion in an update. For example, users might wish to see updates that cover activities of a particular subset of contacts in their social network;
3. Content types. The user can set the types of content that are included in an update. Content types can include both social networking content and non-social networking content such as news, weather, traffic, etc. (note that when talking to a social network site, content is typically limited to data related to the contacts, therefore other content types such as news would be retrieved by talking to a site specifically generating news). The social networking content types may include, for example, private and public comments, profile changes, homepage changes, feedback, blogs, private messages, group messages, calendar updates, reviews (of music, movies, television, products, services, or other technology, etc.), gifts, invitations to events, invitations to be added to a social network, the addition of contacts to a social network, the addition of friends of contacts to a social network, media content (e.g., music, video, photographs, multimedia, ringtones, etc.) and documents that have been shared, and the like;
4. Tastes, likes and dislikes. The user's tastes, likes, and dislikes can provide additional context for the update service 120 when it bundles content to thereby personalize the update to the user. For example, a user might wish to see new blog entries about travel, but not about music, The update service 120 can also employ user tastes, likes, and dislikes when determining whether to fetch related content from non-social networking application sources;
5. Update priority. The user may set the priority of an update or specify the weighting the update service should apply to contacts or content when collecting and/or processing the data. For example, the user may want updates to include certain content types or impose limits on the instances of each content type included in an update. A user may prefer that an update contain more information about what a close friend is doing or choose to give less weight to other contacts and topics. In some cases, the update service 120 can indicate the importance of an update (e.g., high, medium, low) in an image rendered by the digital picture frame 202₆; and
6. Refresh rate. The user can set the frequency with which the update service 120 refreshes its collection of data from the applications 105 and 135 or a particular time period over which data is collected. For example, some users may wish to receive an update that covers developments in their social networks that occur over the course of a day (or some other arbitrary time interval) while other users may wish more frequent updates to cover incremental changes so that the updates more closely show changes as they occur in real time.
   It is emphasized that the list above is intended to be illustrative and other preferences may be utilized as may be required to meet the needs of a particular implementation.

The settings functionality 703₃ enables the user 210 to set parameters such as frame resolution/screen size (e.g., 640×480 pixels, 800×480, 800×600, 1024×768 etc.), time zone, theme colors, and the like. Setting these parameters can help the service tailor the update to the capabilities of a particular digital picture frame.

The terms of service functionality 703_{N} will typically enable the user 210 to review the terms and conditions that govern the use of the update service 120. For example, in usage scenarios where the update service supplies advertising or personalized content, the user will be provided with notice of such supply. The user 210 will also be advised that the collection of data from the applications and any tracking of interactions with the update service will only be used for the provision of the service (which is inherently a personalized service).

In addition, notice will be provided that the collection of any personal information that may occur, for example, when signing up to use the update service (or when obtaining a Windows Live ID) will not be shared with third parties, other than as may be needed to maintain or enhance the quality of the service provided by the update service 120. Other policies that are intended to protect the user's privacy and enhance the quality of the user experience may also be employed. Once the user 210 is informed as to the terms of service, then the user will be given an opportunity to consent to the terms of service.

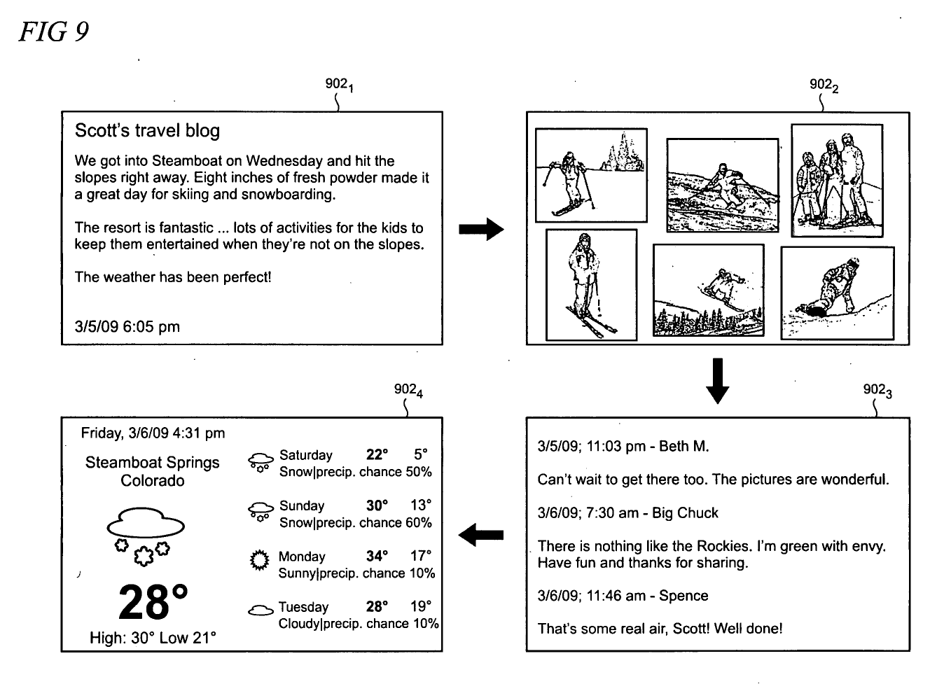

FIGS. 8 and 9 show illustrative images generated by the update service 120 that the digital picture frame 202₆ can render. In FIG. 8, an image 802 is rendered by the digital picture frame 202₆ which shows a summary of updates in a “What's New” page. The updates pertain to social networks and contacts that the user 210 has identified to the update service 120.

Image 802 is representative of social networking updates that the user 210 might choose to be interspersed with other content like photographs that are retrieved in a separate RSS feed from a photo sharing site or from the update service 120. Thus, for example, the user 210 could be viewing photographs from a relative's vacation in a slideshow on the digital picture frame 202₆ and then see the social networking update summary in image 802. At a glance, the summary can alert the user as to the activities that have occurred in a social network of interest about which the user can learn more the next time he or she goes online.

In this example, the image 802 indicates that various people have joined the user's social network, have joined the networks of contacts, have added an entry to a blog, and have shared photographs. A current date/time stamp 805 is included in the image to show the user 210 the freshness of the updates.

FIG. 9 shows an illustrative group of images 902 generated by the update service 120 that the digital picture frame 202₆ can render. In comparison to the image 802 in FIG. 8 which shows a summary of social network developments, the images 902 are arranged to impart more detail and show actual social networking content in accordance with preferences set by the user. In addition, the images 902 show how the update service 120 can use context in order to bundle related items together.

In this example, a contact of the user 210 named “Scott” has authored an entry to his travel blog. Assuming that the user 210 has specified that updates to this particular contact's blog are desired, the update service 120 will collect the blog text from Scott's social networking application and transcode it into an image 902₁ which can be included in an update in the RSS feed 616 (FIG. 6) to the digital picture frame 202₆.

In this example, Scott has posted photographs to his social networking page to accompany his blog entry. The update service 120 can recognize that content which is contextually-related to the blog entry is also available from the social networking application. Alternatively, the user 210 may have explicitly set a preference to receive photographs that Scott uploads to his page. In either scenario, the update service 120 can bundle the contextually-related photographs from the social networking application into a collage 902₂ as shown, or configure them as a sequence of individual images in the RSS feed 616.

Image 902₃, which contains comments from contacts in Scott's social network about the blog entry and photographs, represents additional content that is contextually-related to content that the user 210 has set to receive in an update. Accordingly, the update service 120 can retrieve the comments, bundle the comments together and transcode them as a single image 902₃ or sequence of images in the RSS feed 616 that can be rendered by the digital picture frame 202₆.

Image 902₄, which shows the current weather in the geographic area that is the subject of the blog entry, represents another example of contextually-related content that the update service 120 can retrieve and bundle as an update. However, unlike the photographs and comments that the service retrieves from a social networking application, the weather data can be retrieved from a non-social networking application provider (e.g., application provider 135 in FIG. 1), or the update service 120 can furnish the non-social networking data on its own.

While the weather content is shown as a separate image in FIG. 9, it is emphasized that the social networking content and non-social networking content can be mixed in the same images. For example, the update service 120 can incorporate both an entry in a sports blog and sports headlines retrieved from a news site or RSS feed into the image.

In some implementations the user 210 can exercise additional control over the updates rendered by the digital picture frame 202₆ by working through the frame's user interface and controls. For example, the digital picture frame 202₆ may be configured to pull down the first image 902₁ in the RSS feed from the update service 120 and then give the user 120 a choice as to whether to view the rest of the images 902₂₋₄ in a slideshow immediately or at a later time, for example, by pushing the appropriate buttons on the frame. As noted above, the controls can also be utilized in some cases to indicate to the update service which content can be rendered or how it is rendered, as well as be used to forward content and initiate comments and feedback in some cases.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method performed by an update service, the method comprising the steps of:
collecting data from a social networking application, the social networking application being configured for supporting an online community of users;
processing the collected data, the processing including parsing content by type from the data and bundling parsed content into an update that is indicative of an activity of at least one of the users in the community; and
transcoding the update into a format that is renderable by a non-interactive display device.

2. The method of claim 1 in which the update service is implemented at least in part using computer-readable instructions which execute on a web-based computing device that is accessible from the Internet.

3. The method of claim 1 in which the activities include one or more of joining a social network, posting a comment, uploading media including video, audio, or photographs, adding an entry to a blog, sending a message, sharing content, authoring a review, changing a profile, updating a profile, consuming content, sending or receiving a gift, or authoring content.

4. The method of claim 1 in which the transcoded update is formatted for rendering by the non-interactive display device when configured as a digital picture frame.

5. The method of claim 4 in which the digital picture frame complies with DLNA.

6. The method of claim 1 in which the transcoding comprises generating the update using one or more images.

7. The method of claim 1 in which the transcoding comprises generating the update using one or more videos.

8. The method of claim 1 including a further step of transmitting the update using an RSS feed to the non-interactive display device.

9. The method of claim 1 in which the transcoding is performed to enable rendering by the non-interactive display device, the non-interactive display device being limited to displaying content in image formats and cannot display content in non-image formats, the non-image formats including at least one of text, HTML, or XML.

10. The method of claim 1 including a further step of exposing a user interface to a user of the update service, the user interface being configured to enable the user of the update service to set preferences or to control the processing.

11. The method of claim 1 including a further step of categorizing the content, the categorizing enabling a) contextually-related content to be bundled together in the update, or b) content retrieved from a plurality of services to be bundled together in the update, or c) weighting to be applied to content during processing.

12. One or more computer-readable storage media containing instructions which, when executed by one or more processors disposed in an electronic device, perform a method for processing social networking data into an update for display on a digital picture frame, the method comprising the steps of:
retrieving social networking data from a source, the social networking data being of a plurality of types and being indicative of actions performed by users of an online social network;
categorizing the retrieved social networking data by type;
receiving input from one of the users that is indicative of preferences for one or more of the types;
generating the update from selected portions of the retrieved social networking data in view of the preferences; and
sending the update to the digital picture frame over a network as an RSS feed.

13. The one or more computer-readable storage media of claim 12 in which the retrieving comprises one of interfacing with an API exposed by the source or scraping the social networking data from a web server supported by the source.

14. The one or more computer-readable storage media of claim 12 including a further step of transcoding the selected portions of the retrieved social networking data from a native format into an image format or a video format that is renderable by the digital picture frame.

15. The one or more computer-readable storage media of claim 12 in which the network comprises the Internet.

16. The one or more computer-readable storage media of claim 12 in which an intermediary device receives the update and forwards the update to the digital picture frame.

17. A method for providing a social networking update to a user of a passive consumption device, the method comprising the steps of:
receiving data associated with the social networking update, the data representing one or more actions performed by a user of one or more online social networks;
converting the social networking update from its native format into an image format or video format that is renderable by the passive consumption device; and
sending the image in an RSS feed to the passive consumption device.

18. The method of claim 17 in which the passive consumption device is one of digital picture frame, low-interactive device, non-interactive device, or high-interactive device that is configured to operate as a low-interactive device or non-interactive device.

19. The method of claim 17 including a further step of generating the social networking update by utilizing contextual relationships among the data.

20. The method of claim 19 including a further step of receiving user input that is indicative of one or more preferences and in which the generating is performed responsively to the one or more preferences.
